(19) United States
(12) Patent Application Publication
(10) Pub. No.: US 2009/0255516 A1
(43) Pub. Date: Oct. 15, 2009

(54) SOLENOID VALVE

(76) Inventor: Tatsuya Matsumoto, Tokyo (JP)

Correspondence Address: BIRCH STEWART KOLASCH & BIRCH, PO BOX 747, FALLS CHURCH, VA, 22040-0747, US

(21) Appl. No.: 12/302,778

(22) PCT Filed: May 29, 2007
(86) PCT No.: PCT/JP2007/060923

§ 371 Date: Nov. 26, 2008

(30) Foreign Application Priority Data
Aug. 15, 2006 (JP) 2006-221601

(51) Int. Cl. F02M 33/02; F16K 31/02

(52) U.S. Cl. 123/520; 251/129.15

(57) ABSTRACT

A solenoid valve is directly connected to the intake pipe 28 of an internal combustion engine and controls the supply of fuel to the intake side thereof, wherein the solenoid valve includes a valve body 2 having a valve disk for opening and closing the fuel passage thereof; a solenoid section 3 driving the valve disk; and a stay 4 for securing the valve body 2 to the intake pipe 28, wherein a guard 31 is formed integral with the plate of the valve body 2.

### TECHNICAL FIELD

The present invention relates to a solenoid valve provided integrally with a guard.

### BACKGROUND ART

A gasoline component in a gasoline evaporation gas produced in the fuel tank of a motor vehicle is absorbed or trapped by a canister, and the purified air is discharged to the atmosphere. The gasoline component absorbed by the canister is taken into an internal combustion engine due to the negative pressure generated in an intake pipe during operation of the engine. The amount of the gasoline evaporation gas taken into the internal combustion engine is controlled by a solenoid valve (hereinafter referred to as a purge solenoid valve).

A connection between the vent passage of a purge solenoid valve, and the piping of an intake system and the like is commonly made through a hose; however, recently, with the objectives of (1) reducing the leakage of fuel from connecting sections and (2) reducing the number of piping-connecting steps, a mode of directly attaching a purge solenoid valve to the intake pipe of a throttle body or an intake manifold by inserting the port with an O-ring or the equivalent has been mainstream.

On the other hand, a purge solenoid valve controls the amount of the gasoline evaporation gas, and thus it is necessary to consider the place and mode where the valve is attached such that the passage portion (portion constituting the valve) thereof is not easily damaged even if a large force is exerted on the valve due to a vehicle collision or the like. More specifically, a collision test or the like is done to determine the optimum place and form where a purge solenoid valve is installed.

When a purge solenoid valve is connected with an intake pipe through of the hose, it is comparatively easy to change the place and form where the purge solenoid valve is installed according to the results of the test. However, when the structure that the purge solenoid valve is directly installed in the intake pipe is employed, it is difficult to change the installed place of the valve. As a result, when it is determined that further protection is necessary for the located purge solenoid valve, it is suggested that a guard is provided around the purge solenoid valve. As the method of providing the guard around the purge solenoid valve, it is suggested that a guard which is a member separate from the purge solenoid valve is provided around the valve. Note that Patent Document 1 discloses an art of providing a guard around a solenoid valve.

Patent Document 1: JP-A-2003-074729

When a guard as a separate member is provided around the valve as in a conventional purge solenoid valve, the guard is fastened jointly with the stay of the purge solenoid valve to the intake pipe by a screw. However, in such a jointly fastening structure, if an impact is delivered to the guard, the impact force is transmitted from the guard to the screw to come to a loosened screw, which can loosen the guard and thereby lose a function as the guard.

Note that the solenoid valve disclosed in Patent Document 1 has a structure where a cover member is coupled with a valve body with bolts, similarly to the above-mentioned structure, posing a similar problem. Furthermore, the cover member in the solenoid valve described in Patent Document 1 mainly covers the solenoid portion thereof, not giving protection for the passage portion thereof.

The present invention has been made to solve the above-mentioned technical problems, and an object of the present invention is to provide a purge solenoid valve capable of securely protecting the passage portion thereof.

### DISCLOSURE OF THE INVENTION

The purge solenoid valve according to the present invention controls the supply of fuel to the intake side of an internal combustion engine, wherein the solenoid valve includes a valve body having a valve disk (passage portion) for opening and closing the fuel passage thereof; a solenoid section driving the valve disk; and a stay for securing the valve body to the intake pipe thereof, wherein a guard for protecting the valve disk is formed integral with the solenoid section or the stay.

According to the present invention, since the guard is formed integral with the valve body or the stay, even if the valve receives a shock, the guard is not separated therefrom, thereby providing protection for the valve disk. Further, the integration thereof can reduce the number of parts and also reduce the number of work steps.

### BRIEF DESCRIPTION OF THE DRAWINGS

FIG. 1 is a view of a purge solenoid valve in accordance with the first embodiment of the present invention, (A) is a plan view thereof, and (B) is a front view thereof.

FIG. 2 is a vertically sectional plan view of the valve disk and the solenoid section of the purge solenoid valve in accordance with the first embodiment of the present invention.

FIG. 3 is a view of a purge solenoid valve in accordance with the second embodiment of the present invention, (A) is a plan view thereof, and (B) is a front view thereof.

FIG. 4 is a view of a purge solenoid valve in accordance with the third embodiment of the present invention, (A) is a plan view thereof, and (B) is a front view thereof.

### BEST MODE FOR CARRYING OUT THE INVENTION

Embodiments of the present invention will now be described with reference to the accompanying drawings in order to explain the present invention in more detail.

### First Embodiment

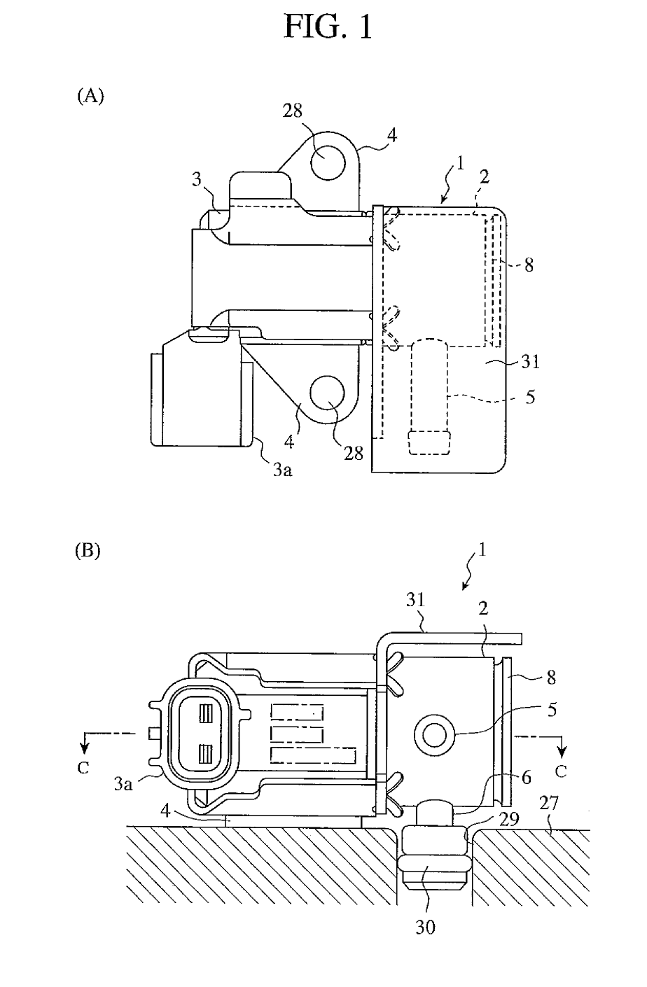

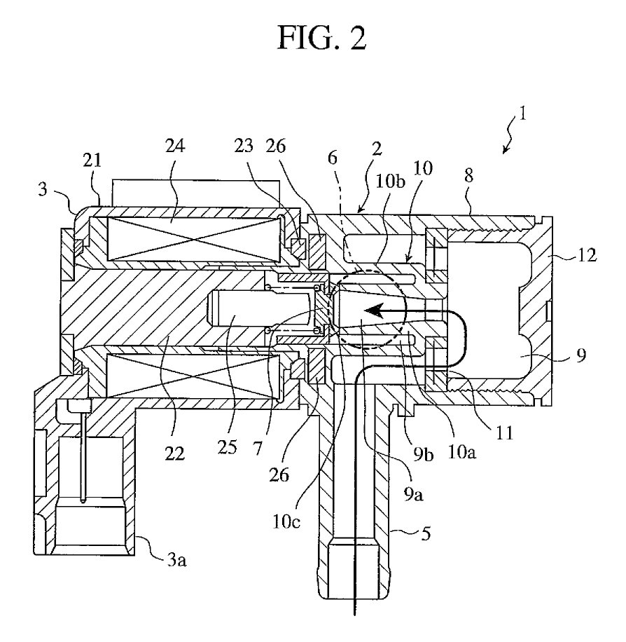

FIG. 1 (A) is a plan view of a purge solenoid valve in accordance with the first embodiment of the present invention, and FIG. 1 (B) is a front view thereof. FIG. 2 is a vertically sectional plan view thereof taken along the line C-C of FIG. 1 (B).

A purge solenoid valve 1 is composed of a valve body 2, a solenoid section 3 driving a valve disk provided within the valve body 2, and a stay 4 formed integral with the underside of the valve body 2.

The valve body 2 is made up of: an inlet port 5 forming an inlet passage; an outlet port 6 that is located at 90 degrees with respect to the inlet port 5 and forms an outlet passage; and a cylindrical valve disk member 8 including a valve disk 7 for providing and closing off communication between the inlet passage and the outlet passage. A passage 9 is formed within the valve disk member 8, and a double pipe section 10 integral with the valve disk member 8 is formed within the passage 9. The double pipe section 10 includes: an internal pipe section 10a and an external pipe section 10b that are concentric to each other, and the inside of the internal pipe section 10a forms an internal passage 9a communicating with the passage 9. The portion between the internal pipe section 10a and the external pipe section 10b forms an external passage 9b. The outlet port 6 is connected with the external pipe section 10b, and the internal passage of the outlet port communicates with the external passage 9b. A filter 11 is provided between the one end section of the double pipe section 10 and the inner wall side of the valve disk member 8. The filter 11 is pressed and fixed against the end section of the double pipe section 10 and the inside of the valve disk member 8 by a cap 12 screwed into the valve disk member 8. The end of the internal pipe section 10a opposite from the filter 11 forms a valve sheet 11c.

The solenoid portion 3 is connected to the opposite side of the valve body 2 from the cap 12 thereof. In the central portion of the cylindrical case 21 of the solenoid section 3, a fixed iron core 22 located on the extended central axis of the double pipe section 10 is provided; the valve disk 7 is located on the tip side of the fixed iron core 22; and the valve disk 23 is pressed against the valve sheet 10c that is the end of internal pipe section 10a by a spring 23 provided between the valve disk 23 and the fixed iron core 22. Meanwhile, a coil 24 surrounding the fixed iron core 22 is provided on the inside of the case 21. A feed connector 3a for supplying power to the coil 24 is provided on the end portion of the solenoid section 3. The valve disk 7 moves in a manner to be pulled back against the energizing force of the spring 23 by the electromagnetic force in the case where the coil 24 is energized. A stopper shaft 25 restricting the movement of the valve disk 7 is provided on the end portion of the double pipe section 10 of the fixed iron core 22. A metal plate 26 as a magnetic-path-forming member is provided on the side of the solenoid section 3 within the valve body 2.

The underside of the valve body 2 is integrally provided with the stay 4 for directly securing the purge solenoid valve 1 to the intake pipe 27 of the internal combustion engine. The stay 4 is provided with bolt holes 28 through which bolts for securing the valve to the intake pipe 27 are passed.

The purge solenoid valve 1 is directly secured to the intake pipe 27. Specifically, the purge solenoid valve 1 is fixed by positioning the stay 4 on the intake pipe 27 and passing the bolts through the bolt holes 28 of the stay 4 to tighten down the bolts to the intake pipe 27. The inlet port 5 is connected with the canister side, and the outlet port 6 is received within a bore 29 provided through the intake pipe 27 through the medium of the O-ring 31. The bore 29 communicates with the intake passage of the intake pipe 27.

The amount of the gasoline evaporation gas supplied from the canister side to the intake pipe 27 is controlled about the amount by opening and closing of the valve disk 7. The valve disk 7 is opened when it is axially moved by energizing the solenoid section 3 against the energizing force of the spring 23. The gasoline evaporation gas is fed from the inlet port 5 to the valve body 2, and fed to the internal passage 9a of the internal pipe section 10a in the double pipe section 10 by way of the filter 11. The gasoline evaporation gas leads to the outlet port 6 by way of the external passage 9b by virtue of the fact that the valve disk 7 is separated from the valve sheet 10c, and is supplied into the intake pipe 27.

When an automobile receives a large external force due to a collision or the like, in the purge solenoid valve 1, it is necessary to protect the valve disk member 8 of the valve body 2 having the valve disk 7 for providing and closing off communication between the canister side and the intake pipe side. For this reason, in the first embodiment, as shown in FIG. 1 (A) and FIG. 1 (B), the guard 31 covering the valve disk member 8 of the valve body 2 and the inlet port 5 thereof is formed integral with the plate 26. In practice, it is arranged that the plate 26 and the guard 31 be formed integral with each other by use of a metal and the portion of the plate 26 be embedded in the valve body 2. The shape and board thickness of the guard 31 are determined in consideration of the direction and force of an impact to be applied thereto.

Even if an impact force is exerted to the guard 31, the purge solenoid valve 1 prevents the guard 31 from being separated from the valve body 2 because the guard is formed integral with the plate 26, and the valve protects the valve disk member 8 involving the valve disk 7 for providing and closing off communication between the canister side and the intake pipe side. Therefore, the leakage of the gasoline evaporation gas due to the destruction of the valve disk 7 does not occur.

Further, the purge solenoid valve 1 eliminates the necessity for providing the guard 31 as a separate member by virtue of the integration of the plate 26 and the guard 31, can reduce the number of parts, and can reduce the manufacturing costs.

Moreover, the integral structure of the plate 26 and the guard 31 can reduce the space in comparison with the case where separate members are provided, and can offer numerous advantages particularly when the purge solenoid valve is disposed in the vicinity of the intake pipe having no room in space.

### Second Embodiment

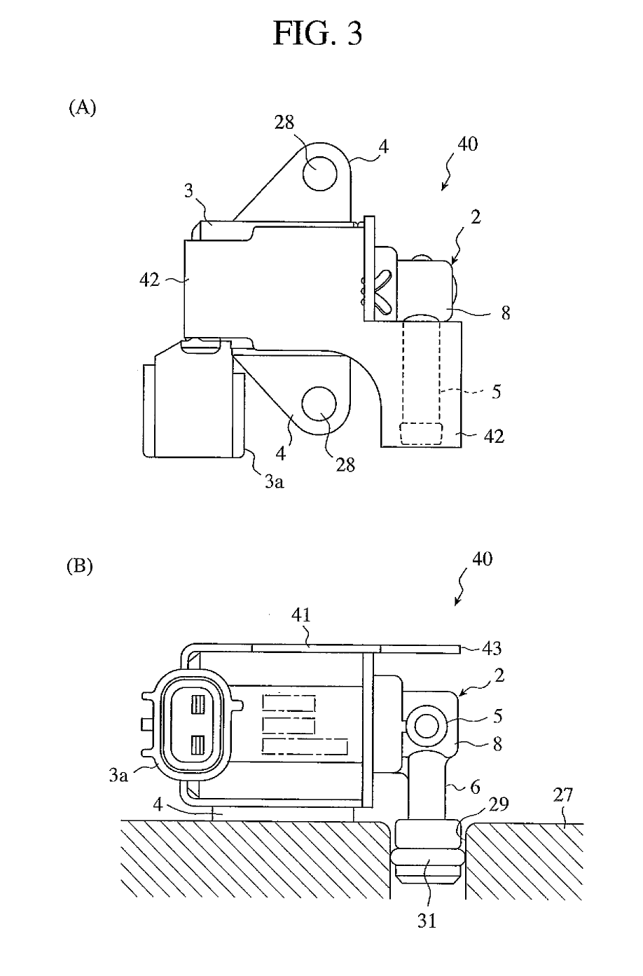

FIG. 3 (A) and FIG. 3 (B) are a plan view and a front view of a purge solenoid valve in accordance with the second embodiment, respectively.

The purge solenoid valve 40 is characterized in that a guard 42 is formed integral with a yoke 41 that is a magnetic-path-forming member and formed outside a solenoid section 3. The shape and board thickness of the guard 42 are determined in consideration of the direction and force of an impact. Other structures of the purge solenoid valve 40 are the same as those of the first embodiment shown in FIG. 1(A) and FIG. 1(B).

The purge solenoid valve 40 in the second embodiment can produce functional effects similar to those of the first embodiment. To be more specific, the guard 42 is formed integral with the yoke 41, even if an impulse force is applied to the guard 42, the guard is not separated from the valve body 2 and always protects the valve body 2. The valve body 2 including therein a valve disk for providing and closing off communication between the canister side and the intake pipe 27 side is protected, and thus the leakage of the evaporation gasoline gas due to the destruction of the valve disk does not occur.

Further, according to the purge solenoid valve 40, the guard 42 is formed integral with the yoke 41, thus eliminating the necessity for providing the guard 42 as a separated member. Thus the number of parts thereof is reduced and cost reduction thereof is achieved. Moreover, the integration of the yoke 41 and the guard 42 can reduce the space as compared with the case provided by separate members, and thus has a great advantage when the purge solenoid valve 40 is disposed in the vicinity of the intake pipe 27 having no room in space.

### Third Embodiment

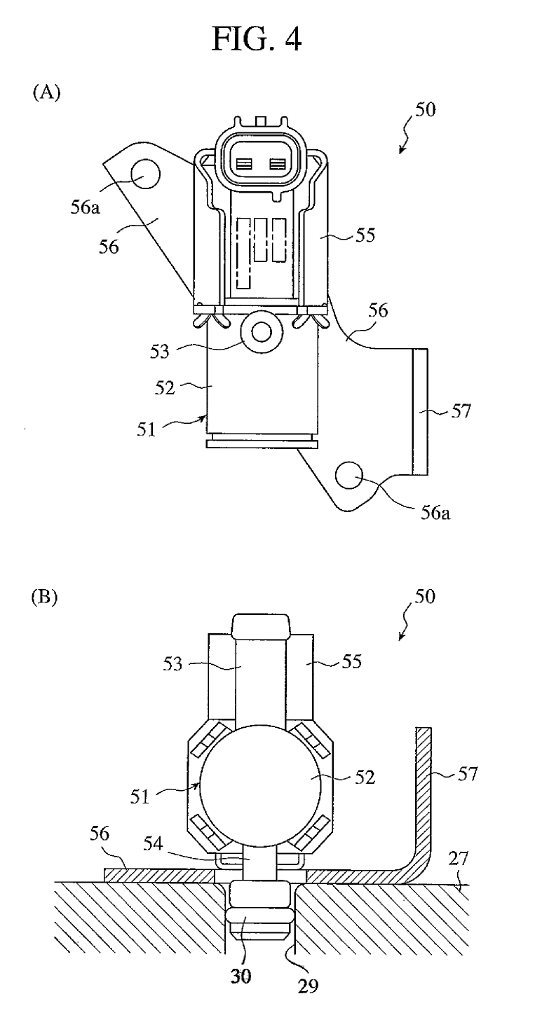

FIG. 4(A) and FIG. 4(B) are a plan view and a front view of a purge solenoid valve 50 in accordance with the third embodiment, respectively.

The purge solenoid valve 50 in accordance with the third embodiment is different from the ones in accordance with the first and the second embodiments in the shape of the purge solenoid valve itself. A valve body 51 is made up of a valve disk member 52 including a valve disk therein, and an inlet port 53 and an outlet port 54 that are connected with the valve disk member 52. The inlet port 53 and the outlet port 54 are connected to each other and formed in a straight line. The valve disk provided within the valve disk member 52, and providing and closing off communication through the passage formed by the inlet port 53 and outlet port 54, has a structure similar to that of the valve disk shown in FIG. 2. The valve body 51 is provided with a solenoid section 55 attached thereto and working the valve disk to open and close, and also has a structure similar to that of the valve body shown in FIG. 2.

The outlet port 54 side of the valve body 51 is integrally provided with a metal stay 56 for directly securing the purge solenoid valve 50 to the intake pipe. In the state shown in FIG. 4 (A), the stay 56 is formed diagonally extending to both sides of the valve body 51, and each of the extended portions thereof is provided with a bolt hole 56a for securing the valve body to the intake pipe 27 with bolts. Further, a guard 57 is formed integral with the stay 56 as rising perpendicularly with respect to the stay 56. The shape and board thickness of the guard 57 are determined in consideration of the direction and force of an impact. In the third embodiment, though the guard 57 is formed perpendicularly with respect to the stay 56, it may also be formed to cover the valve body 2 with a further bending manner.

The purge solenoid valve 50 is directly secured to the intake pipe 27. The purge solenoid valve 50 is fixed by positioning the stay 56 on the intake pipe 27 and passing bolts through the bolt holes 56a of the stay 56 to tighten down the bolts to the intake pipe 27. The inlet port 53 is connected with the canister side, while the outlet port 54 is received within a bore 29 provided through the intake pipe 27 with an attached O-ring 30.

The purge solenoid valve 50 in the third embodiment can produce functional effects similar to those of the first embodiment. To be more specific, the guard 57 is formed integral with the stay 56, even if an impulse force is applied to the guard 57, the guard is not separated from the valve body 51 and always protects the valve body 51. The valve body 51 including therein the valve disk for providing and closing off communication between the canister side and the intake pipe side is protected, and thus the leakage of a gasoline evaporation gas due to the destruction of the valve disk does not occur.

Further, according to the purge solenoid valve 50, the guard 57 is formed integral with the stay 56, thus eliminating the necessity for providing the guard 57 as a separated member. Thus the number of parts thereof is reduced and cost reduction thereof is achieved. Besides, the integration of the stay 56 and the guard 57 can reduce space as compared with the case provided by separate members and thus has a great advantage when the purge solenoid valve is disposed in the vicinity of the intake pipe having no room in space.

### INDUSTRIAL APPLICABILITY

As mentioned hereinabove, the solenoid valve according to the present invention is a solenoid valve where the guard is provided integral with the valve body or stay; the guard is prevented from being separated from the valve body to protect the valve disk even when receiving an impulse; and further, such an integration can reduce the number of parts and work steps thereof, and thus the solenoid valve is suitable for use in a solenoid valve to be installed in the internal combustion engine of a motor vehicle and so on.

1. A solenoid valve that is directly connected to an intake pipe of an internal combustion engine and controls the supply of fuel to the intake side thereof, wherein the solenoid valve comprises:
a valve body having a valve disk for opening and closing the fuel passage thereof;
a solenoid section driving the valve disk; and
a stay for securing the valve body to the intake pipe,
wherein a guard for protecting the valve disk is formed integral with the solenoid section or the stay.

2. The solenoid valve according to claim 1 wherein the guard is formed integral with a yoke of the solenoid section.

3. The solenoid valve according to claim 1 wherein the guard is formed integral with a plate of the solenoid section.

4. The solenoid valve according to claim 1 wherein the guard is formed integral with the stay.
